(19) United States
(12) Patent Application Publication
(10) Pub. No.: US 2020/0009427 A1
(43) Pub. Date: Jan. 9, 2020

(54) SCREEN BADMINTON PRACTICE DEVICE

(71) Applicant: TL-Industry Co., Ltd., Daejeon (KR)

(72) Inventor: Chang-sik KIM, Daejeon (KR)

(73) Assignee: TL-Industry Co., Ltd., Daejeon (KR)

(21) Appl. No.: 16/338,747

(22) PCT Filed: Apr. 30, 2018
(86) PCT No.: PCT/KR2018/005004

§ 371 Date: Apr. 2, 2019

(30) Foreign Application Priority Data
May 2, 2017 (KR) 10-2017-0056274

(51) Int. Cl. A63B 47/02; A63B 67/18; A63B 69/00; A63B 69/40; A63B 71/06; B65G 15/20; B65G 37/00; B65G 65/32

(52) U.S. Cl. CPC A63B 47/025; A63B 67/18; A63B 69/0017; A63B 69/40; A63B 2102/04; B65G 15/20; B65G 37/00; B65G 65/32; A63B 2071/0638; A63B 71/0622

(57) ABSTRACT

Provided is a screen badminton practice device enabling badminton, even while alone, to be played like a real game or practiced, and enabling shuttlecocks to be automatically collected and loaded, the screen badminton practice device comprising: a screen provided at one side of a practice location; a beam projector for projecting an image on the screen; a shuttlecock shooting part, which is provided at the rear of the screen, has a storage container, provided at the upper part thereof, for storing a plurality of shuttlecocks, and withdraws and shoots the shuttlecocks stored in the storage container; and a shuttlecock collection part collecting the shuttlecocks, which fall on the lower part of the practice location, so as to fill the storage container with the same.

### TECHNICAL FIELD

The present invention relates to a badminton practice device, and more particularly to a screen badminton practice device, which enables a user to conveniently enjoy badminton practice or a badminton game regardless of the number of players and which is configured to automatically collect shuttlecocks that have fallen on the floor and to supply the shuttlecocks to a shuttlecock-shooting unit.

### BACKGROUND ART

In general, badminton is a sport where players hit a shuttlecock using rackets toward an opposing side over a net installed at the center of a court in order to score points.

A shuttlecock used for badminton includes a cork part, which is formed so as to be hit by a racket, and a cone part, which is made up of wings for realizing stable flight.

Badminton is a sport that anyone can enjoy anytime and anywhere with just a little space and is therefore the most popular racket sport for the public.

A badminton player is not capable of practicing hitting or receiving a shuttlecock alone without an opponent. Recently, devices for shooting a shuttlecock to a user have been developed and are being widely used.

Korean Patent Laid-open Publication No. 2009-0050205 discloses a badminton shuttlecock-shooting machine, which shoots a badminton shuttlecock using an air compressor.

Korean Patent Registration No. 1292661 discloses a shuttlecock-shooting machine, in which a propelling device propels a shuttlecock using the elastic restoring force of an elastic member in order to shoot the shuttlecock.

Korean Patent Registration No. 1731052 discloses a badminton practice device, which is configured such that a plurality of shuttlecocks stored in a storage container is drawn and supplied to a shuttlecock-shooting unit disposed below the storage container by a supply unit and such that the shuttlecock-shooting unit shoots the shuttlecock forwards.

With the development of shuttlecock-shooting machines, such as those disclosed in Korean Patent Laid-open Publication No. 2009-0050205, Korean Patent Registration No. 1292661 and Korean Patent Registration No. 1731052, it is possible for one player or one team to practice badminton. However, it is still impossible for one player or one team to play a badminton game.

When using the device disclosed in Korean Patent Laid-open Publication No. 2009-0050205, Korean Patent Registration No. 1292661 or Korean Patent Registration No. 1731052, a user needs to manually collect used shuttlecocks.

### DISCLOSURE

### Technical Problem

Therefore, the present invention has been made in view of the above problems, and it is an object of the present invention to provide a screen badminton practice device, which enables one user or one team of two users to play a badminton game like a real game or to practice badminton, whereby the user is capable of conveniently enjoying badminton anytime regardless of the number of users, and which is configured to easily collect shuttlecocks.

### Technical Solution

A screen badminton practice device according to the present invention includes a screen installed at one side of a practice facility, a beam projector configured to project an image on the screen, a shuttlecock-shooting unit installed at the rear of the screen, the shuttlecock-shooting unit including a storage container disposed at an upper side thereof to store a plurality of shuttlecocks and being configured to shoot the shuttlecocks drawn from the storage container, and a shuttlecock-collecting unit configured to collect the shuttlecocks that have fallen on the floor of the practice facility and to load the shuttlecocks in the storage container.

The shuttlecock-collecting unit may include a first conveyor including a conveyor belt wound around a driving belt pulley and a driven belt pulley so as to circulate, the first conveyor conveying the shuttlecocks loaded on the conveyor belt from the practice facility and unloading the shuttlecocks at a position directly below the shuttlecock-shooting unit, a second conveyor installed at the rear of the first conveyor, the second conveyor including a pair of ropes, each being wound around a corresponding one of a pair of driving rope pulleys and a corresponding one of a pair of driven rope pulleys so as to circulate, the ropes being disposed opposite each other so that opposite sides of each of the shuttlecocks unloaded from the first conveyor are supported between the ropes in an upright state, the second conveyor conveying the shuttlecocks horizontally and unloading the shuttlecocks at a position below the shuttlecock-shooting unit, and a third conveyor installed near the second conveyor, the third conveyor including a pair of ropes, each being wound around a corresponding one of a pair of driving rope pulleys and a corresponding one of a pair of driven rope pulleys so as to circulate, the ropes being disposed opposite each other so that opposite sides of each of the shuttlecocks unloaded from the second conveyor are supported between the ropes in an upright state, the third conveyor conveying the shuttlecocks in a diagonally upward direction and unloading the shuttlecocks at a position above the storage container disposed at the upper side of the shuttlecock-shooting unit.

Each of the ropes may be made of urethane rubber and may be formed to have a circular-shaped cross-section.

The shuttlecock-collecting unit may further include a transfer conveyor configured to load the shuttlecocks unloaded from the second conveyor onto the third conveyor.

The transfer conveyor may include a pair of ropes, each being wound around a corresponding one of a pair of driving rope pulleys and a corresponding one of a pair of driven rope pulleys so as to circulate, the ropes being disposed opposite each other so that the shuttlecocks unloaded from the second conveyor are supported between the ropes, the transfer conveyor conveying the shuttlecocks in a diagonally downward direction and unloading the shuttlecocks on a region between the pair of ropes of the third conveyor that is located at one end portion of the third conveyor.

The second conveyor may be installed at the rear of the first conveyor, the second conveyor including a cylindrical-shaped horizontal housing having a guide slot formed in a portion thereof in the longitudinal direction thereof and a screw rotatably provided inside the horizontal housing, the guide slot being formed so that opposite sides of each of the shuttlecocks unloaded from the first conveyor are supported between opposite edges of the guide slot in an upright state, the second conveyor conveying the shuttlecocks due to rotation of the screw and unloading the shuttlecocks at a position below the shuttlecock-shooting unit.

The third conveyor may be installed near the second conveyor, the third conveyor including a cylindrical-shaped slanted housing having a guide slot formed in a portion thereof in the longitudinal direction thereof and a screw rotatably provided inside the slanted housing, the guide slot being formed so that opposite sides of each of the shuttlecocks are supported between opposite edges of the guide slot, the third conveyor conveying the shuttlecocks in a diagonal direction due to rotation of the screw and unloading the shuttlecocks at a position above the storage container disposed at the upper side of the shuttlecock-shooting unit.

A motion recognition camera and an auxiliary motion recognition camera may be installed at opposite upper sides of the practice facility.

The motion recognition camera may sense the motion of shuttlecocks, a user and a racket located in a photographing area from one upper side of the practice facility.

The auxiliary motion recognition camera may sense the motion of shuttlecocks, a user and a racket located in the photographing area from the opposite upper side of the practice facility.

### Advantageous Effects

The screen badminton practice device according to the embodiment of the present invention enables one user or one team of two users to play a badminton game like a real game or to practice badminton, whereby the user is capable of conveniently enjoying badminton anytime regardless of the number of users.

In addition, the screen badminton practice device according to the embodiment of the present invention is capable of completely automatically collecting shuttlecocks that have fallen on the badminton court and loading the collected shuttlecocks, thereby facilitating the use and maintenance thereof and reducing the labor and time necessary for collecting the shuttlecocks.

### DESCRIPTION OF DRAWINGS

FIG. 1 is a side view illustrating a screen badminton practice device according to a first embodiment of the present invention.

FIG. 2 is a front view illustrating the screen badminton practice device according to the first embodiment of the present invention.

FIG. 3 is a side view illustrating a first conveyor of the shuttlecock-collecting unit of the screen badminton practice device according to the first embodiment of the present invention.

FIG. 4 is a side view illustrating a second conveyor of the shuttlecock-collecting unit of the screen badminton practice device according to the first embodiment of the present invention.

FIG. 5 is a plan view illustrating the second conveyor of the shuttlecock-collecting unit of the screen badminton practice device according to the first embodiment of the present invention.

FIG. 6 is a side view illustrating a third conveyor of the shuttlecock-collecting unit of the screen badminton practice device according to the first embodiment of the present invention.

FIG. 7 is a plan view illustrating the third conveyor of the shuttlecock-collecting unit of the screen badminton practice device according to the first embodiment of the present invention.

FIG. 8 is a transverse cross-sectional view illustrating the third conveyor of the shuttlecock-collecting unit of the screen badminton practice device according to the first embodiment of the present invention.

FIG. 9 is a front view illustrating a transfer conveyor of the shuttlecock-collecting unit of the screen badminton practice device according to the first embodiment of the present invention.

FIG. 10 is a front view illustrating another example of the transfer conveyor of the shuttlecock-collecting unit of the screen badminton practice device according to the first embodiment of the present invention.

FIG. 11 is a longitudinal cross-sectional view illustrating a second conveyor of a shuttlecock-collecting unit of a screen badminton practice device according to a second embodiment of the present invention.

FIG. 12 is a transverse cross-sectional view illustrating the second conveyor of the shuttlecock-collecting unit of the screen badminton practice device according to the second embodiment of the present invention.

FIG. 13 is a longitudinal cross-sectional view illustrating a third conveyor of a shuttlecock-collecting unit of a screen badminton practice device according to a third embodiment of the present invention.

FIG. 14 is a transverse cross-sectional view illustrating the third conveyor of the shuttlecock-collecting unit of the screen badminton practice device according to the third embodiment of the present invention.

FIG. 15 is a side view illustrating a screen badminton practice device according to a fourth embodiment of the present invention.

### BEST MODE

Hereinafter, preferred embodiments of a screen badminton practice device according to the present invention will be described in detail with reference to the accompanying drawings.

In the following description, technical elements having the same functions are denoted by the same reference numerals, and a duplicate explanation thereof is omitted.

The embodiments described herein are only proposed for illustrative purposes in order to effectively show the preferred embodiments of the present invention, and should not be construed as restricting the spirit or scope of the invention.

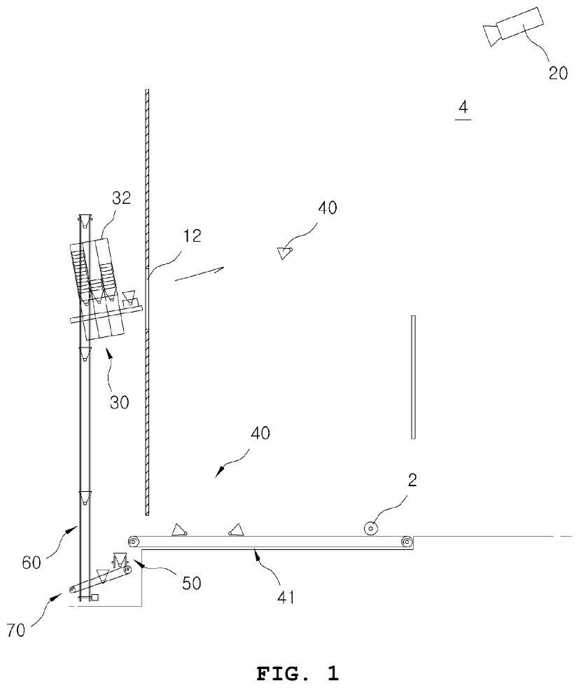

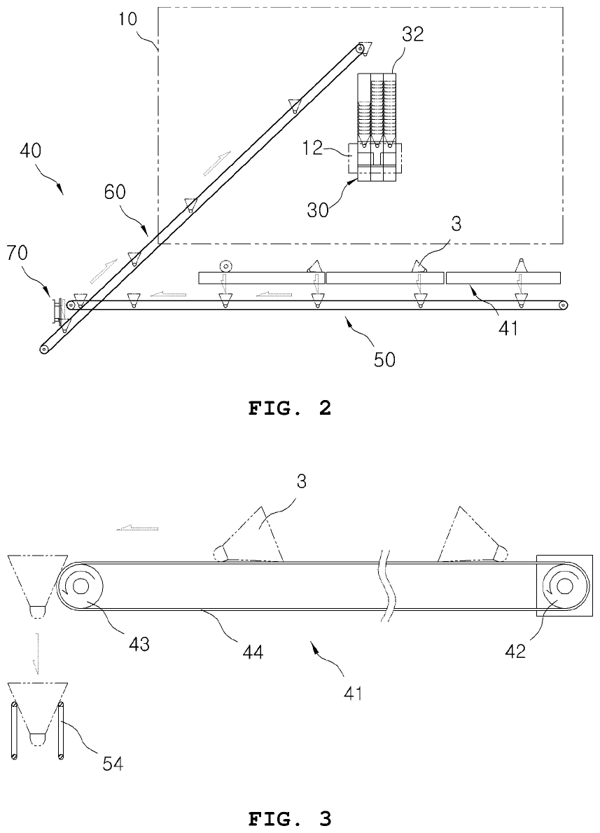

First, a screen badminton practice device according to a first embodiment of the present invention, as illustrated in FIGS. 1 and 2, includes a screen 10, which is installed at one side of a practice facility 4, a beam projector 20, which projects an image on the screen 10, a shuttlecock-shooting unit 30, which is installed at the rear of the screen 10, the shuttlecock-shooting unit including a storage container 32 disposed at an upper side thereof to store a plurality of shuttlecocks 3 and being configured to shoot the shuttlecock drawn from the storage container 32 in the forward direction of the screen 10, and a shuttlecock-collecting unit 40, which collects the shuttlecocks 3 that have fallen on the floor of the practice facility 4 and loads the shuttlecocks 3 in the storage container 32.

In the drawings, the dashed arrows indicate the directions in which the shuttlecock 3 is conveyed.

A net 5 may be installed across the region ahead of the screen 10 in the practice facility 4.

The screen 10 displays an image projected by the beam projector 20 on the front surface thereof.

The screen 10 may be secured to the wall surface or to the ceiling of the practice facility 4.

The screen 10 may be installed vertically or may be installed at an incline at a predetermined angle in the rearward direction.

The screen 10 may have therein a through-hole 12, through which the shuttlecock 3 launched from the shuttlecock-shooting unit 30, which is installed at the rear of the screen 10, flies forwards.

The beam projector 20 is installed at the wall surface or the ceiling of the practice facility 4, and projects a pre-stored image or a real-time image on the screen 10.

An image input to the beam projector 20 may be a virtual image, a real image, or the like.

The shuttlecock-shooting unit 30 is installed so as to shoot the shuttlecock 3 at a height of about 1 to 2.5 m from the floor of the practice facility 4, preferably at a height of 1.3 to 2 m.

The storage container 32 is formed in a substantially cylindrical shape having a length of about 0.3 to 1.5 m, and is installed upright.

The lower end of the storage container 32 is disposed higher than the position from which the shuttlecock 3 is launched.

Since a well-known shuttlecock-shooter may be used as the shuttlecock-shooting unit 30, a more detailed explanation thereof is omitted.

The shuttlecock-collecting unit 40 includes a first conveyor 41, a second conveyor 50, a third conveyor 60, and a transfer conveyor 70.

The first conveyor 41, as illustrated in FIG. 3, includes a conveyor belt 44, which is wound around a driving belt pulley and a driven belt pulley 43 so as to circulate. The shuttlecock 3 is loaded on the conveyor belt 44 from the practice facility 4 and is conveyed and unloaded from the conveyor belt 44 at a position directly below the shuttlecock-shooting unit 30.

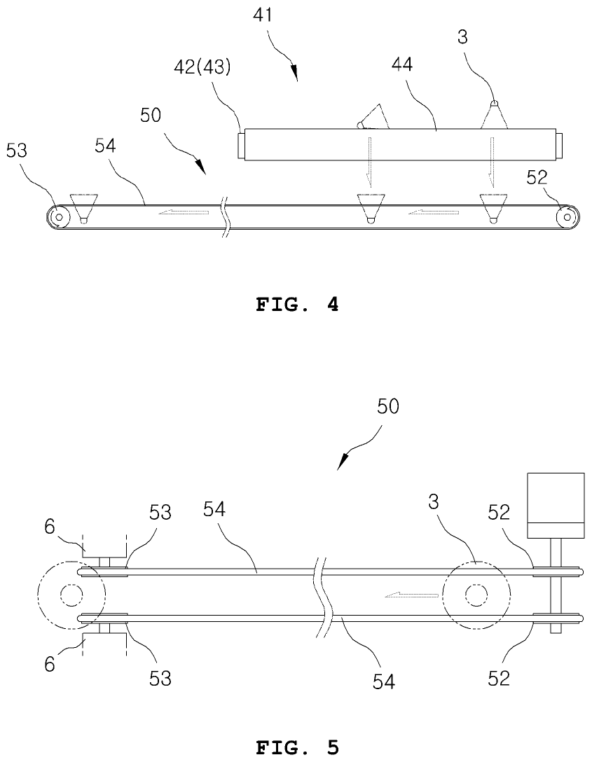

The second conveyor 50, as illustrated in FIGS. 3 to 5, includes a pair of ropes 54, each of which is wound around a corresponding one of a pair of driving rope pulleys 52 and a corresponding one of a pair of driven rope pulleys 53 so as to circulate, the ropes 54 being disposed opposite each other so that opposite sides of the shuttlecock 3 unloaded from the first conveyor 41 are supported between the ropes 54 in an upright state. The shuttlecock 3 is conveyed horizontally and is unloaded from the ropes 54 at a position below the shuttlecock-shooting unit 30.

The second conveyor 50 conveys the shuttlecock 3 in a direction perpendicular to the first conveyor 41.

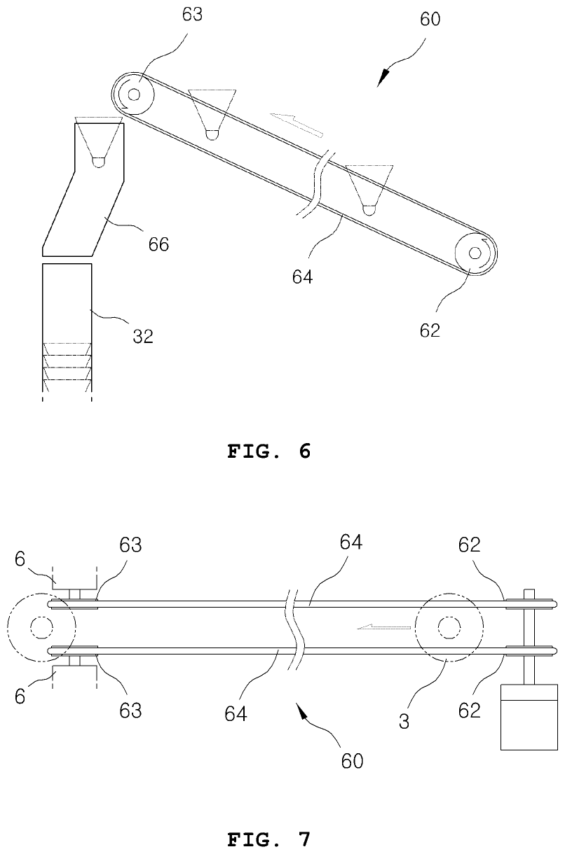

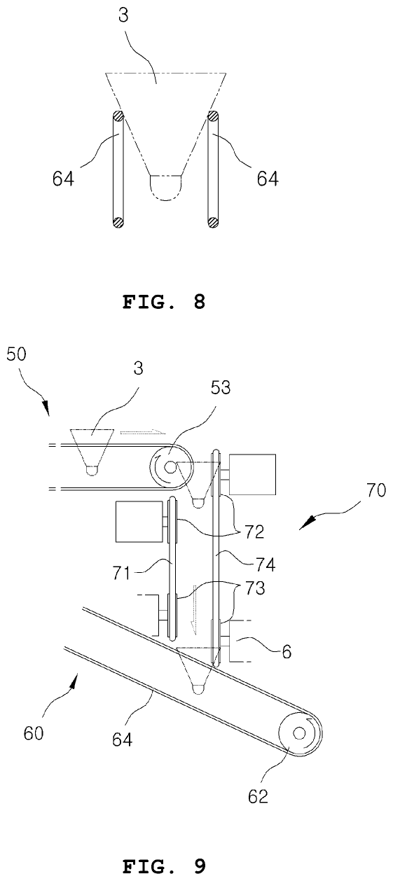

The third conveyor 60, as illustrated in FIGS. 6 to 8, is installed near the second conveyor 50, and includes a pair of ropes 64, each of which is wound around a corresponding one of a pair of driving rope pulleys 62 and a corresponding one of a pair of driven rope pulleys 63 so as to circulate, the ropes 64 being disposed opposite each other so that opposite sides of the shuttlecock 3 unloaded from the second conveyor 50 are supported between the ropes 64 in an upright state. The shuttlecock 3 is conveyed in a diagonally upward direction and is unloaded from the ropes 64 at a position above the storage container 32 disposed at the upper side of the shuttlecock-shooting unit 30.

The third conveyor 60 is spaced a predetermined distance apart from the second conveyor 50 in a rearward direction so as to be parallel therewith in order to convey the shuttlecock 3.

The ropes 54 and 64 included in the second conveyor 50 and the third conveyor 60 are made of rubber and are formed to have circular-shaped cross-sections.

The ropes 54 and 64 may be formed of urethane rubber. Since urethane rubber has excellent durability, high friction and elasticity, the cone part of the shuttlecock 3 may be maintained in close contact with the pair of ropes 54 and 64 therebetween while being conveyed.

One end portion (the lower end portion) of the third conveyor 60 is disposed lower than the second conveyor 50 so that the shuttlecock 3 unloaded from the second conveyor 50 is more easily loaded on the third conveyor 60.

The above-described shuttlecock-collecting unit 40 may further include a cylindrical-shaped connection passage pipe for guiding the shuttlecock 3 unloaded from the third conveyor 30 to the storage container 32.

The transfer conveyor 70 loads the shuttlecock 3 unloaded from the second conveyor 50 onto the third conveyor 60.

The transfer conveyor 70, as illustrated in FIG. 9, includes a pair of ropes 74, each of which is wound around a corresponding one of a pair of driving rope pulleys 72 and a corresponding one of a pair of driven rope pulleys 73 so as to circulate, the ropes 74 being disposed opposite each other so that the shuttlecock 3 unloaded from the second conveyor 50 is supported between the ropes 74. The shuttlecock 3 is conveyed in a diagonally downward direction and is unloaded on a region between the pair of ropes 64 of the third conveyor 60 that is located at one end portion (the lower end portion) of the third conveyor 60.

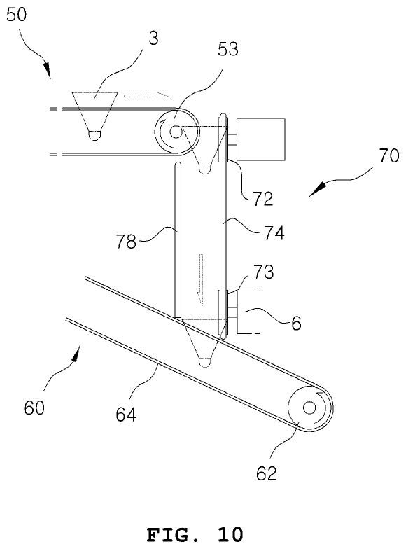

As illustrated in FIG. 10, the transfer conveyor 70 may be configured such that the driving rope pulley 72, the driven rope pulley 73 and the rope 74 are provided at one side thereof and such that a guide rail 78 is installed at an incline at the opposite side thereof.

Thus, one side of the shuttlecock 3 may slide along the guide rail 78 in a diagonally downward direction, and the opposite side of the shuttlecock 3 may be conveyed by the rope 74 while being in contact therewith.

The rope 74 is made of rubber and is formed to have a circular-shaped cross-section.

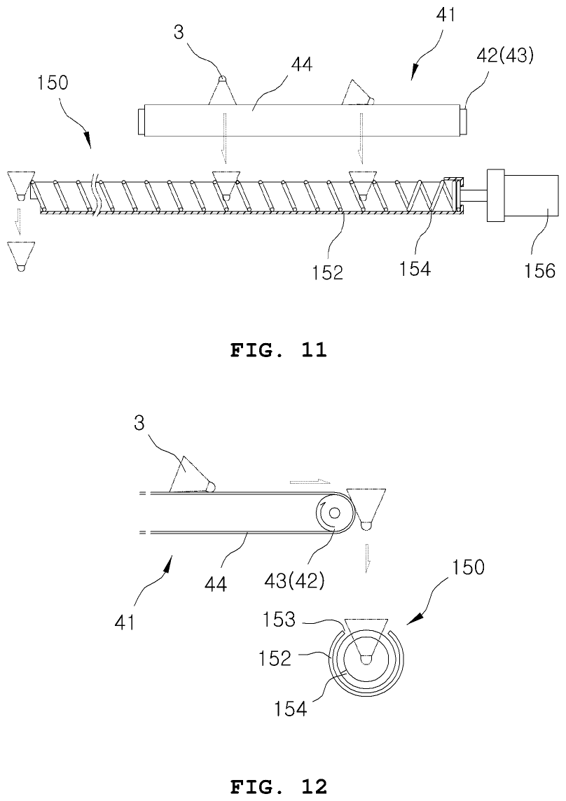

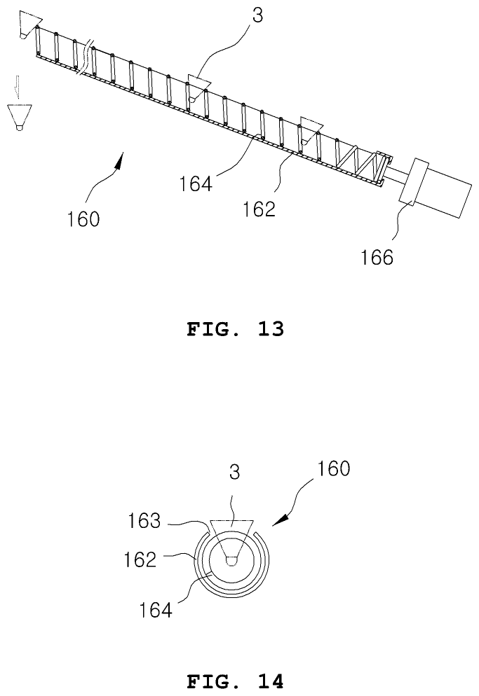

A screen badminton practice device according to a second embodiment of the present invention may be configured such that a second conveyor 150, as illustrated in FIGS. 11 and 12, includes a cylindrical-shaped horizontal housing 152 having a guide slot 153 formed in a portion thereof in a longitudinal direction thereof and a screw 154 rotatably provided inside the horizontal housing 152. The guide slot 153 is formed so that opposite sides of the shuttlecock 3 unloaded from the first conveyor 41 are supported between opposite edges of the guide slot 153 in an upright state. The shuttlecock 3 is conveyed by the rotation of the screw 154 and is unloaded therefrom at a position below the shuttlecock-shooting unit 30.

The horizontal housing 152 is formed to have a substantially C-shaped cross-section.

That is, the body of the horizontal housing 152 is configured as a substantially cylindrical-shaped pipe, and the guide slot 153 is formed in a portion of the body in a longitudinal direction thereof so as to have a straight line shape.

Constructions other than the above-described construction in the second embodiment may be the same as those in the first embodiment described above, and a detailed explanation thereof is therefore omitted.

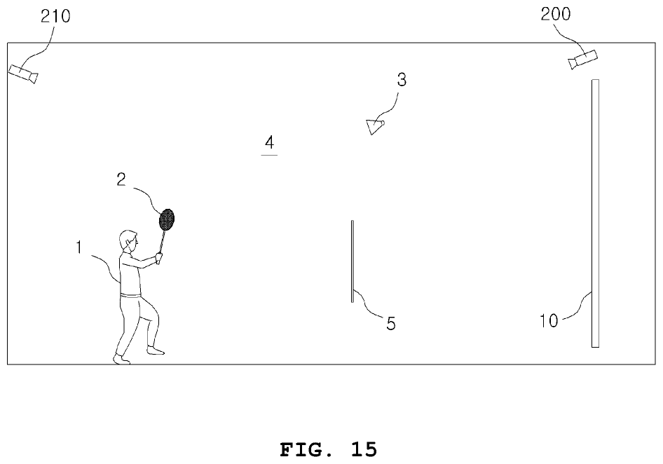

A screen badminton practice device according to a third embodiment of the present invention may be configured such that a third conveyor 160, as illustrated in FIGS. 13 and 14, includes a cylindrical-shaped slanted housing 162 having a guide slot 163 formed in a portion thereof in the longitudinal direction thereof and a screw 164 rotatably provided inside the slanted housing 162. The guide slot 163 is formed so that opposite sides of the shuttlecock 3 are supported between opposite edges of the guide slot 163. The shuttlecock 3 is conveyed in a diagonal direction by the rotation of the screw 164 and is unloaded therefrom at a position above the storage container 32 disposed at the upper side of the shuttlecock-shooting unit 30.

Like the horizontal housing 152, the slanted housing 162 is formed to have a substantially C-shaped cross-section.

The screw 154 and 164 is formed by winding a coil in a spiral shape. For example, the screw is of a coil-spring type.

The screw 154 and 164 may be embodied as a male screw, which is widely used for fastening or fixing of parts, adjustment of distance, power transmission, conveyance of objects, etc.

The male screw may be formed to have a triangular thread, a square thread, a trapezoidal thread, a round thread, or the like.

The screw 154 and 164 receives rotational force from a rotation driving source 156 and 166 such as a motor and is rotated thereby.

Constructions other than the above-described construction in the third embodiment may be the same as those in the first embodiment or the second embodiment described above, and a detailed explanation thereof is therefore omitted.

A screen badminton practice device according to a fourth embodiment of the present invention, as illustrated in FIG. 15, further includes a motion recognition camera 200 and an auxiliary motion recognition camera 210.

The motion recognition camera 200 photographs the practice facility 4 from an upper side of the practice facility 4 and senses the motion of the shuttlecock 3, a user 1, a racket 2, etc. located in the photographing area.

The motion recognition camera 200 is capable of recognizing the motion of the shuttlecock 3, the user 1, the racket 2, etc., thereby sensing the moving trace of the hit or launched shuttlecock 3, including the moving direction, the moving distance, the speed, etc. thereof.

The motion recognition camera 200 provides the sensed moving trace of the shuttlecock 3 to the beam projector 20, and the beam projector 20 projects an image corresponding to the moving trace of the shuttlecock 3 (e.g. an image showing the movement of the shuttlecock or the like) on the screen 10.

The auxiliary motion recognition camera 210 photographs the practice facility 4 from a position opposite the motion recognition camera 200 in the practice facility 3 and senses the motion of the shuttlecock 3, the user 1, the racket 2, etc. located in the photographing area.

The auxiliary motion recognition camera 210 is capable of recognizing the motion of the shuttlecock 3, the user 1, the racket 2, etc. together with the motion recognition camera 200, thereby sensing the moving trace of the shuttlecock 3 that was hit, including the moving direction, the moving distance, the speed, etc. thereof.

The motion recognition camera 200 and/or the auxiliary motion recognition camera 210 is also capable of transmitting a control signal corresponding to the sensed moving trace to the shuttlecock-shooting unit 40.

That is, it is possible to transmit a shooting control signal to the shuttlecock-shooting unit 40 so that the shuttlecock-shooting unit 40 shoots the shuttlecock 3 to the user 1 so as to correspond to the moving trace of the shuttlecock 3.

The auxiliary motion recognition camera 210 provides the sensed moving trace of the shuttlecock 3 to the beam projector 20, and the beam projector 20 projects an image corresponding to the moving trace of the shuttlecock 3 (e.g. an image showing the movement of the shuttlecock, or the like) on the screen 10.

The motion recognition camera 200 and the auxiliary motion recognition camera 210 recognize motion from opposite sides of the practice facility 4, thereby sensing movement from various directions and consequently sensing the moving trace more accurately.

The motion recognition camera 200 and the auxiliary motion recognition camera 210 may be installed on the wall, the ceiling, or the like of the indoor facility.

Constructions other than the above-described construction in the fourth embodiment may be the same as those in the first embodiment or the second embodiment described above, and a detailed explanation thereof is therefore omitted.

Although the preferred embodiments of the screen badminton practice device according to the present invention have been disclosed, the present invention is not limited thereto. Various variations are possible within the scope of the accompanying claims, the detailed description of the present invention, and the drawings, and consequently, such variations should be understood to fall within the scope and spirit of the invention.

What is claimed is:

1. A screen badminton practice device comprising:
a screen installed at one side of a practice facility;
a beam projector configured to project an image on the screen;
a shuttlecock-shooting unit installed at a rear of the screen, the shuttlecock-shooting unit comprising a storage container disposed at an upper side thereof to store a plurality of shuttlecocks and being configured to shoot the shuttlecocks drawn from the storage container; and
a shuttlecock-collecting unit configured to collect the shuttlecocks that have fallen on a floor of the practice facility and to load the shuttlecocks in the storage container.

2. The screen badminton practice device according to claim 1, wherein the shuttlecock-collecting unit comprises:
a first conveyor comprising a conveyor belt wound around a driving belt pulley and a driven belt pulley so as to circulate, the first conveyor conveying the shuttlecocks loaded on the conveyor belt from the practice facility and unloading the shuttlecocks at a position directly below the shuttlecock-shooting unit;
a second conveyor installed at a rear of the first conveyor, the second conveyor comprising a pair of ropes, each being wound around a corresponding one of a pair of driving rope pulleys and a corresponding one of a pair of driven rope pulleys so as to circulate, the ropes being disposed opposite each other so that opposite sides of each of the shuttlecocks unloaded from the first conveyor are supported between the ropes in an upright state, the second conveyor conveying the shuttlecocks horizontally and unloading the shuttlecocks at a position below the shuttlecock-shooting unit; and
a third conveyor installed near the second conveyor, the third conveyor comprising a pair of ropes, each being wound around a corresponding one of a pair of driving rope pulleys and a corresponding one of a pair of driven rope pulleys so as to circulate, the ropes being disposed opposite each other so that opposite sides of each of the shuttlecocks unloaded from the second conveyor are supported between the ropes in an upright state, the third conveyor conveying the shuttlecocks in a diagonally upward direction and unloading the shuttlecocks at a position above the storage container disposed at the upper side of the shuttlecock-shooting unit.

3. The screen badminton practice device according to claim 2, wherein the shuttlecock-collecting unit further comprises a transfer conveyor configured to load the shuttlecocks unloaded from the second conveyor onto the third conveyor, and
wherein the transfer conveyor comprises a pair of ropes, each being wound around a corresponding one of a pair of driving rope pulleys and a corresponding one of a pair of driven rope pulleys so as to circulate, the ropes being disposed opposite each other so that the shuttlecocks unloaded from the second conveyor are supported between the ropes, the transfer conveyor conveying the shuttlecocks in a diagonally downward direction and unloading the shuttlecocks on a region between the pair of ropes of the third conveyor that is located at one end portion of the third conveyor.

4. The screen badminton practice device according to claim 2, wherein each of the ropes is made of urethane rubber and is formed to have a circular-shaped cross-section.

5. The screen badminton practice device according to claim 1, wherein the shuttlecock-collecting unit comprises:
a first conveyor comprising a conveyor belt wound around a driving belt pulley and a driven belt pulley so as to circulate, the first conveyor conveying the shuttlecocks loaded on the conveyor belt from the practice facility and unloading the shuttlecocks at a position directly below the shuttlecock-shooting unit;
a second conveyor installed at a rear of the first conveyor, the second conveyor comprising a cylindrical-shaped horizontal housing having a guide slot formed in a portion thereof in a longitudinal direction thereof and a screw rotatably provided inside the horizontal housing, the guide slot being formed so that opposite sides of each of the shuttlecocks unloaded from the first conveyor are supported between opposite edges of the guide slot in an upright state, the second conveyor conveying the shuttlecocks due to rotation of the screw and unloading the shuttlecocks at a position below the shuttlecock-shooting unit; and
a third conveyor installed near the second conveyor, the third conveyor comprising a cylindrical-shaped slanted housing having a guide slot formed in a portion thereof in a longitudinal direction thereof and a screw rotatably provided inside the slanted housing, the guide slot being formed so that opposite sides of each of the shuttlecocks are supported between opposite edges of the guide slot, the third conveyor conveying the shuttlecocks in a diagonal direction due to rotation of the screw and unloading the shuttlecocks at a position above the storage container disposed at the upper side of the shuttlecock-shooting unit.

6. The screen badminton practice device according to claim 5, wherein the shuttlecock-collecting unit further comprises a transfer conveyor configured to load the shuttlecocks unloaded from the second conveyor onto the third conveyor, and
wherein the transfer conveyor comprises a pair of ropes, each being wound around a corresponding one of a pair of driving rope pulleys and a corresponding one of a pair of driven rope pulleys so as to circulate, the ropes being disposed opposite each other so that the shuttlecocks unloaded from the second conveyor are supported between the ropes, the transfer conveyor conveying the shuttlecocks in a diagonally downward direction and unloading the shuttlecocks on a region between the pair of ropes of the third conveyor that is located at one end portion of the third conveyor.

7. The screen badminton practice device according to claim 1, further comprising:
a motion recognition camera configured to photograph the practice facility from an upper side of the practice facility and to sense motion of the shuttlecocks, a user and a racket located in a photographing area; and
an auxiliary motion recognition camera configured to photograph the practice facility from an opposite upper side of the practice facility and to sense motion of the shuttlecocks, the user and the racket located in the photographing area.
